(19) United States
(12) Patent Application Publication
(10) Pub. No.: US 2015/0343656 A1
(43) Pub. Date: Dec. 3, 2015

(54) DEVICE FOR THE COMMINUTION OF FOODSTUFFS

(71) Applicant: Genius GmbH, Limburg (DE)

(72) Inventor: Cedomir REPAC, Brechen (DE)

(21) Appl. No.: 14/654,560

(22) PCT Filed: Dec. 20, 2013
(86) PCT No.: PCT/EP2013/077791

§ 371 Date: Jun. 22, 2015

(30) Foreign Application Priority Data
Dec. 28, 2012 (DE) 10 2012 224 519.7

(51) Int. Cl. B26D 3/18; B26D 3/26; E05D 7/10; B26D 1/30

(52) U.S. Cl. CPC B26D 3/185; B26D 1/30; B26D 3/26; E05D 7/1072

(57) ABSTRACT

The invention relates to a device (1) for the comminution of foodstuffs, having a base part (3) which has a receptacle for a cutting part (6) and to which an actuation part (4) can be articulatedly fixed such that, for pushing through food items (20) for comminution, the actuation part (4) can be pivoted toward the cutting part (6). The device (1) is characterized in that a food slicer (5) is provided which, as a replacement for the actuation part (4) or in addition to the actuation part (4), is articulatedly fixable or fixed to the base part (3), or in that the actuation part (4) has a support (8) to which at least one plunger element (7) is fixable or fixed, preferably in detachable fashion, and in that a food slicer (5) forms the support (8) or has the support (8).

### CROSS-REFERENCE TO RELATED APPLICATIONS

The present application is the U.S. national phase of International Application No. PCT/EP2013/077791 filed Dec. 20, 2013, which claims priority of German Application No. 10 2012 224 519.7 filed Dec. 28, 2012, the entirety of which is incorporated herein by reference.

### FIELD OF THE INVENTION

The invention relates to a device for the comminution of foodstuffs, having a base part which has a receptacle for a cutting part and to which an actuation part can be articulatedly fixed such that, for pushing through food items to be comminuted, the actuation part can be pivoted toward the cutting part.

### BACKGROUND OF THE INVENTION

Appliances of the type mentioned in the introduction for the comminution of relatively small food items such as mushrooms, for example, are known for example in the form of handheld appliances.

For example, DE 102 42 651 A1 has described a cutting appliance for foodstuffs or similar items for cutting, having a cutting part on which there are fitted multiple substantially parallel blades which have cutting edges, said cutting edges forming a cutting surface for the items for cutting in order to cut said items into strips or slices or similar. An actuation part in the form of a plunger has a base surface which can be moved toward and away from the cutting surface, with the items for cutting situated in between. The base surface has groove-like or slot-like receptacles which substantially correspond to the blades and which have interposed webs. The base surface acts on the items for cutting and moves these toward the cutting surface and through between the blades. It is provided that the cutting part and the plunger are arranged in the region of the free end of a respective arm of the tongs, wherein the arms of the tongs are pivotably connected in the region of the other, free end by means of a pivot bearing, and wherein the arms of the tongs are preloaded into an open position by means of a spring.

A similar appliance with a special cutting blade arrangement is known from DE 20 2007 018 922 U1.

The appliances mentioned above are appliances which are held in one hand, similarly to a pair of tongs, and in the case of which the comminution process is performed by closing the hand in which the comminution device is held, with two arms of the tongs being pushed together as a result.

As described below, appliances also exist which are of completely different design, and which are not held in the hand but which are placed on a worktop. These appliances normally have a container for the comminuted items. The only common aspect that these appliances share with the appliances mentioned above is the comminution principle, specifically the fact that the items for comminution are pushed through a cutting device.

For example, DE 10 2009 023 167 A1 discloses a device for cutting foodstuffs, such as fruit and vegetables, having a cutting part which has multiple cutting edges, and having an actuation part, said cutting part and actuation part being mounted so as to be pivotable relative to one another. To cut the items for cutting, the actuation part is pushed towards the cutting part, wherein the actuation part has a plunger which pushes the items for cutting through the cutting part, wherein the cutting edges protrude into corresponding depressions of the plunger. The cutting part has a cutting frame in which cutting blades are held. The device furthermore has a cover part for mounting on a receiving container for the cut items for cutting, wherein the cover part has an opening which forms a passage for the cut items for cutting.

Other devices for placing on a worktop are known for example from DE 20 2011 050 041 U1 and from DE 21 2005 000 048 U1.

U.S. Pat. No. 1,263,151 has disclosed a device in which, depending on cutting requirements, one cutting insert out of a multiplicity of different stored cutting inserts for the comminution of food items is installed.

Various food slicers are known from GB 2 032 260 A, EP 1 918 078 A2 and DE 91 10 587 U1. Said food slicers firstly have a horizontal blade, and may secondly also have vertical blades on their cutting side. The horizontal blade serves for slicing or cutting the food items into slices, and the additional vertical blades serve for cutting the food items into strips.

DE 20 2009 011 687 U1 has disclosed a kitchen slicer which comprises a cutting part. The cutting part has a slideway for a food item and has a slicer blade arranged parallel to the slideway. By means of an adjusting device, the distance between the planes of the slideway and of the slicer blade can be varied, and thus different cutting thicknesses for the food item can be set. Furthermore, the cutting slicer comprises a cutting grid and a pushing device for manually pushing food items through the cutting grid.

WO 2011/064723 A2 has disclosed a food slicer device having a cutting grid which comprises two plates which can be manually pivoted toward one another and which are fastened to one another. A receiving vessel for a food item is attached to one plate, the base plate. The other plate, the slicer platform, has a through opening with a cutting grid situated therein. The receiving vessel and the through opening are positioned such that, as the plates are pivoted toward one another, the food item is pushed through the cutting grid and cut into pieces. By means of a slicer carriage which slides on the slicer platform, the food item can then additionally be sliced and comminuted further.

The preparation of meals that are common nowadays, such as for example salads, requires widely varied options for the comminution of different food items. Firstly, it is for example necessary for one food item, for example a cucumber, to be sliced for the preparation of a salad. Secondly, for the preparation of the same salad, it is additionally necessary for a further food item, for example cheese or meat items, to be cut by being pushed through a cutting part. For the preparation of such meals, different implements are required, which each operate specifically on the basis of exclusively one predefined comminution principle and which are used entirely separately from one another. After the comminution processes, the user must bring together the food items that have been comminuted using the different implements, in order that said food items can be mixed with one another, for example for the preparation of a mixed salad.

### SUMMARY OF THE INVENTION

It is therefore the object of the present invention to specify a device which makes it possible for food items to be comminuted in different ways.

Said object is achieved by means of a device of the type mentioned in the introduction, which is characterized in that a food slicer is provided which, as a replacement for the actuation part or in addition to the actuation part, is articulatedly fixable or fixed to the base part.

The device according to the invention has the advantage that hitherto separate devices for comminution can be utilized in complementary fashion in one device. This means in particular that the user no longer needs to use two mutually separate and different devices for slicing one food item and for cutting an other food item by pushing it through a cutting part.

Moreover, it may even be provided that, after a first comminution process in which an actuation part has been used for pushing food items through a cutting part and in which the comminuted items that have been pushed through have been collected in a container, a food slicer is fitted in place of the actuation part, such that a different food item can be sliced, with the food item comminuted in this way being collected in the same container. In particular, a retroactive transfer of the different food items into a common bowl in which they can be mixed is rendered unnecessary in this way.

Owing to the articulated connection of the food slicer, the user furthermore has the very particular advantage that he or she can, without great effort, in particular even when the base part is fixed to a container opening, pivot the food slicer upward in order, for example, to check how full the container is or in order to remove food items that have become stuck on the rear side of the cutting mechanism of the food slicer.

As is stated in more detail further below, the invention has the further advantage that a control element for the adjustment of the cutting thickness or the cutting pattern may be provided on the rear side of the food slicer, which control element can be easily accessed by way of the pivoting of the food slicer relative to the base part from a working position (preferably horizontal position) into an access position (preferably a vertical position).

A further advantage of the device is that the user has to perform fewer working steps for the comminution of food items, whereby the working effort that must be expended by the user is reduced. Furthermore, a further advantage consists in that it is less cumbersome and easier to clean and service a single device than two mutually separate devices.

Rather than exchanging the actuation part for a food slicer, it may advantageously also be provided that the food slicer that is pivotably mounted on the base part forms, together with a pressing plunger that can be joined on, an actuating part for pushing items for comminution through a cutting part. Such an embodiment has the particular advantage that it makes do with a particularly small number of components. For example, the pressing plunger may be fixed to the support by way of a simple plug-type connection and/or a detent connection.

The articulated connection between the base part and the actuation part and the articulated connection between the base part and the food slicer may be realized in different ways. What are particularly advantageous are articulated connections which can be joined together and detached again in a simple manner, in particular without tools and/or by way of a simple plugging-together and pulling-apart action.

In a particular embodiment, the base part, on the one hand, has at least one joint head and the actuation part and/or the food slicer, on the other hand, has a corresponding joint receptacle for forming the articulated connection. It may self-evidently also conversely be provided that the actuation part and/or the food slicer, on the one hand, has at least one joint head and the base part, on the other hand, has a corresponding joint receptacle for forming the articulated connection.

In a particular embodiment, the articulated connection is designed such that the actuation part or the food slicer, at least in a predefined pivoting position, is detachable from the base part, in particular without tools and/or exclusively by virtue of the actuation part and base part being pulled apart. In particular, the articulated connection may also be designed such that the actuation part or the food slicer, exclusively in a predefined pivoting position or in a predefined pivoting position range, is detachable from the base part, in particular without tools and/or exclusively by virtue of the actuation part and base part being pulled apart.

The predefined pivoting position may for example lie at an angle in the range from 80° to 100°, in particular at an angle of 90°, between the plane of the base part and the plane of the actuation part. The two planes are characterized in that they have a common straight line of intersection which is parallel to the axis of rotation of the actuation part and the base part. In particular, it may also be provided that the predefined pivoting position range has an angle range of 70° to 110°, in particular of 80° to 100°, in particular of 85° to 95°, between the plane of the base part and the plane of the actuation part.

In a particular embodiment, to realize detachability of the articulated connection, the joint head receptacle has a radial opening through which the joint head can be removed from or inserted into the joint head receptacle in a radial direction. It may very generally be provided that the joint head receptacle has an opening through which the joint head can be removed from or inserted into the joint head receptacle along a direction that differs from the direction of the pivot axis of the articulated connection.

In particular, in the case of one of the abovementioned devices, it may advantageously be provided that the joint head is of non-circular, in particular rectangular, form in cross section. Specifically, in a particular pivoting position, a joint head of said type can be inserted into the joint head receptacle through the opening of the joint head receptacle, whereas, in a different pivoting position, said joint head cannot exit the joint head receptacle through said opening.

In a very particularly advantageous embodiment, the device has at least one drive device, in particular a spring drive, for assisting or effecting the pivoting movement of the actuation part and/or of the food slicer from a closed position into a loading position and/or from a loading position into a closed position.

A device of said type has in particular the very special advantage that it can be operated using one arm. It may for example be provided that the user uses one hand to place items for comminution onto the cutting part and subsequently uses the other hand to pivot the actuation part toward the cutting part and thus place a spring of a drive device, which is in the form of a spring drive, under stress. Under the action of the force imparted by the stressed spring, the actuation part can, after the comminution process has taken place, move back automatically—that is to say without the user having to hold the base part with one hand—from the closed position into the loading position again. The user can consequently use one hand exclusively for placing further items for comminution onto the cutting part after every comminution process, while using the other hand exclusively for pivoting the actuation part from the loading position into the closed position.

In this way, it is possible for a significantly greater quantity of food items to be processed in the same length of time, because the procedures can be carried out very much more quickly and without the user having to change their grip, which is inconvenient and time-consuming.

In one advantageous embodiment, it is provided that the drive device is selectively activatable or deactivatable and/or or that the assistance force of the drive device is adjustable.

A deactivation is preferably realized by virtue of the actuation part being freely pivotable relative to the base part when the drive device is deactivated. It may however also be provided that a deactivation is realized by virtue of pivoting of the actuation part relative to the base part no longer being possible.

Such an embodiment has the advantage that it can be adjusted, in accordance with the type of items for comminution, such that a fast and efficient comminution process is always made possible.

For example, in the case of a device in which the drive device has at least one spring which is placed under stress during the pivoting of the actuation part from the loading position into the closed position and which relaxes so as to assist the pivoting movement of the actuation part from the closed position into the loading position, a deactivation of the drive device may be realized if particularly hard foods are to be comminuted, for which purpose the user requires their full force in any case. This prevents a situation in which the user must additionally impart energy for placing the spring under stress during the pivoting of the actuation part from the loading position into the closed position.

By contrast, for the comminution of foodstuffs which can be pushed through the cutting part by means of the actuation part with little expenditure of force, the drive may be activated; for example in order to assist or automatically effect the pivoting of the actuation part from the closed position into the loading position.

In the case of a device in which the assistance force of the drive device is adjustable, it is advantageously possible, for example in a manner dependent on the cuttability of the foodstuff, for an intermediate setting between full deactivation and full activation to be selected.

In a particular embodiment, the base part has a passage for the comminuted foodstuff. It may be provided in particular that the receptacle for the cutting part provides, when no cutting part is inserted into the receptacle, a passage for the food items comminuted by means of the food slicer. To convert the device from cutting by pushing items through to cutting using the food slicer, it is necessary merely for the cutting part to be removed from the receptacle and either for the actuation part to be replaced with the food slicer or for the pressing plunger to be removed from the food slicer which is form formed as a support.

In a particularly individually usable embodiment, it is provided that multiple cutting parts can be inserted simultaneously into the receptacle and/or in that cutting parts of different size can be inserted into the receptacle.

As already mentioned, it may advantageously be provided that the food slicer has at least one control element by means of which a cutting thickness and/or a cutting pattern can be adjusted. Said control element may in particular be arranged on that side of the food slicer which faces away from the cutting side of the food slicer, and/or on a rear side, oriented in the ejection direction, of the food slicer. In this way, laterally protruding components of the control element, which would pose an obstruction in particular during a pivoting movement, are eliminated entirely. In particular, this prevents a situation in which parts of the control element inadvertently collide with the base part during the execution of a pivoting movement. In particular, in the case of such an embodiment, the base part does not need to be shaped in a special way in order to provide space for a control element.

The device may in particular be designed to be placed on a worktop for a comminution process. For example, the device may have a stand, for example with supporting feet, for placing on a worktop. In particular, a container for collecting the comminuted foodstuff may also be designed, and function, as a stand.

The device may advantageously be in the form of a cover which can be mounted on a container—preferably so as to completely cover the container opening—and/or can be fixed to a container. The comminuted foodstuff can in this way be safely and reliably collected in the container. In particular, in this way, it is also realized that undesired articles are prevented from passing into the meal in the container. This applies in particular in the case of multiple meals being prepared simultaneously in a kitchen area. Furthermore, removal of the device after use is not necessary in order to attach a separate cover. This applies in particular in the case of short time intervals between periods of use of the device.

In a further embodiment, instead of the food slicer which, as a replacement for the actuation part or in addition to the actuation part, is articulatedly fixable or fixed to the base part, the actuation part has a support. At least one pressing plunger is fixable or fixed—preferably in detachable fashion—to the support, wherein a food slicer forms the support or has the support. In this embodiment, the device has at least one drive device, in particular a spring drive, advantageously for assisting or effecting the pivoting movement of the actuation part and/or of the food slicer from a closed position into a loading position and/or from a loading position into a closed position.

In a particular embodiment, the base part is in the form of a container for the comminuted foodstuff. Furthermore, a container of said type may also be in the form of a stand for enabling the food comminution device to be placed on a worktop.

However, regardless of whether or not the base part is also in the form of a container, it may advantageously be provided that the base part is additionally in the form of a stand for enabling the food comminution device to be placed on a worktop or has a stand for enabling the food comminution device to be placed on a worktop.

What is very particularly advantageous is a kitchen appliance which has a container for collecting the comminuted items and a food comminution device according to the invention which is designed as a cover for the container. In this case, it may advantageously be provided in particular that the food comminution device in the form of a cover can be mounted on the container so as to completely cover the container opening. In particular, it may additionally be provided that, for a comminution process, the food comminution device can be fixed temporarily to the container edge, for example by way of a screw connection or by way of a detent connection.

It is advantageously possible for the kitchen appliance to be designed to be placed on a worktop for a comminution process.

It may for example be provided that the container of the kitchen appliance is in the form of a stand for enabling the food comminution device to be placed on a worktop. For example, supporting feet, in particular non-slip supporting feet composed of rubber or some other elastic material, may be arranged on the outer side of the base of the container.

### BRIEF DESCRIPTION OF THE DRAWING VIEWS

The subject matter of the invention is schematically illustrated in the drawing and will be described below on the basis of the figures, wherein identical elements or elements of identical action are normally denoted by the same reference signs. In the drawing:

FIG. 1 shows a cross section, from a side elevation, of an exemplary embodiment of a device according to the invention, having a base part and an actuation part,

FIG. 2 shows a cross section, from a side elevation, of the exemplary embodiment of a device according to the invention, having a base part and a food slicer,

FIG. 3 shows a cross section, from a side elevation, of a different exemplary embodiment of a device according to the invention, having a food slicer, having a pressing plunger attached thereto and having a base part,

FIG. 4 shows a cross section, from a side elevation, of a further exemplary embodiment of a device according to the invention, having a base part which has two different cutting parts,

FIG. 5 shows, in a side view, an enlarged illustration of the joint, in a position of the actuation part in which the latter encloses an internal angle of 90° with the base part,

FIG. 6 shows, in a side view, an enlarged illustration of the joint, in a position of the actuation part in which the latter encloses an internal angle of 0° with the base part.

### DETAILED DESCRIPTION OF THE INVENTION

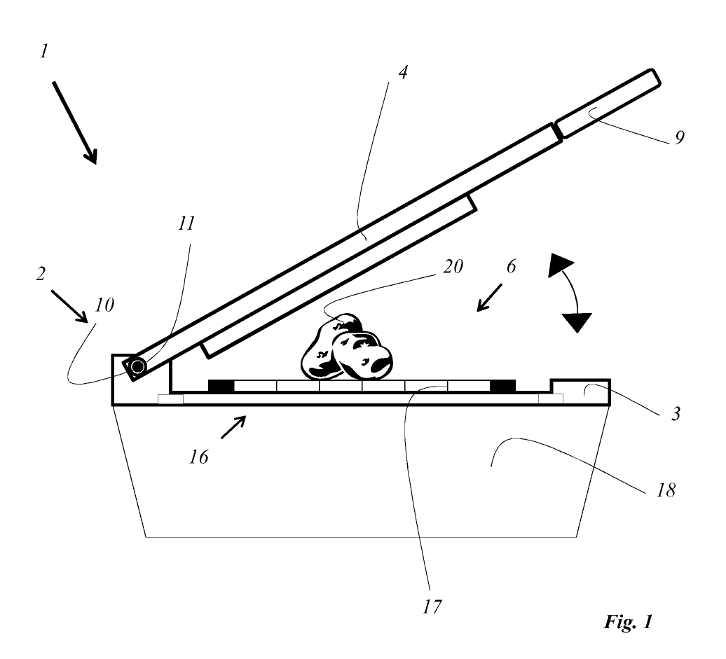

FIG. 1 shows a cross section, from a side elevation, of an exemplary embodiment of a device 1 according to the invention, having a base part 3 and an actuation part 4 which are connected to one another by way of a joint 2. The joint 2 has a joint head 10 and a joint receptacle 11 which at least partially encloses the joint head 10. A handle 9 is fastened to the actuation part 4. The base part 3 is mounted on a container 18 and has a receptacle 16. In the receptacle 16 there is arranged a cutting part 6, wherein the cutting part 6 has cutting part blades 17 illustrated as thin lines. Furthermore, in FIG. 1, there is a curved double arrow which indicates the possible pivoting directions for the actuation part 4 about the joint 2.

The illustrated device 1 is used as follows: a user places a food item 20 onto the cutting part 6 and can thereupon push said food item through the cutting part 6 by pivoting the actuation part 4 toward the cutting part 6. As the food item 20 is pushed through the cutting part 6, the food item 20 is cut into pieces by the cutting part blades 17. The comminuted food item 20 falls into the container 18 and is collected there.

The user can also cut different food items 20 in succession by way of the cutting part 6. Alternatively, it is also possible for multiple food items 20 to be placed onto the cutting part 6, and cut into pieces, simultaneously. The user may likewise exchange the cutting part 6 for a different cutting part, for example in order to realize different cutting forms and/or in order to cut a different food item 20 into pieces. In this case, the cutting process using the different cutting part takes place analogously to that described above.

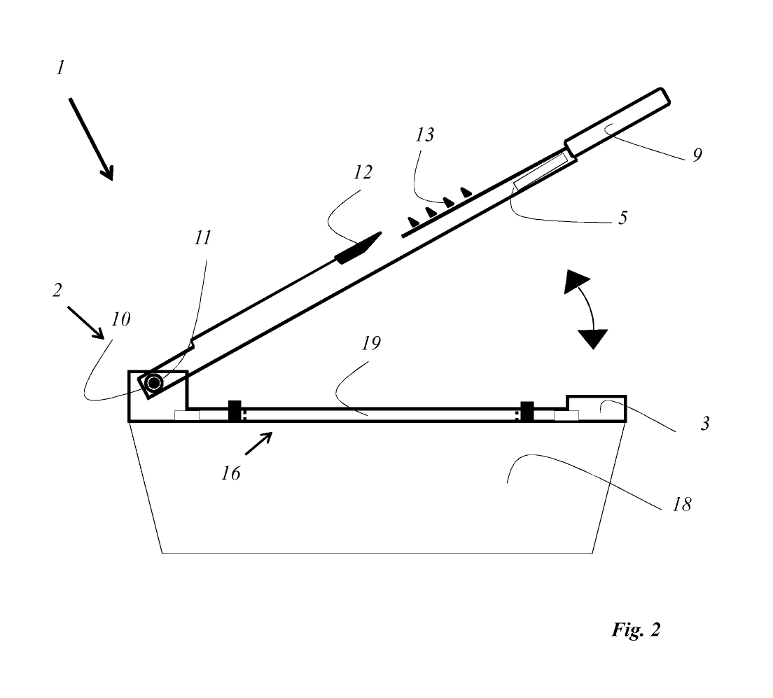

FIG. 2 shows a cross section, from a side elevation, of an exemplary embodiment of the device 1 according to the invention, in which the actuation part 4 has been replaced with a food slicer 5. The base part 3 is mounted on a container 18 and, by contrast to the embodiment illustrated in FIG. 1, does not have a cutting part 6. As it is the case, analogously to the situation illustrated in FIG. 1, that the base part 3 has a receptacle 16, but no cutting part 6 is arranged therein, the food items 20 can pass into the container 18 through a through opening 19 provided in particular in the receptacle 16.

The food slicer 5 is articulatedly connected to the base part 3 by way of the joint 2 and has a cutting edge 12 for slicing and several vertical cutting blades 13 for cutting the food items 20 into pieces. A handle 9 is attached to the food slicer 5 in order to make the latter easier for the user to operate.

For the slicing of a food item 20, the actuation part 4 is pivoted from the position illustrated in FIG. 2 in the direction of the base part 3 into a working position. In the working position, the food slicer 5 is situated at its closest to the through opening 19 in spatial terms. Furthermore, in the working position, the working axis of the food slicer 5, along which the items for slicing are moved back and forth, is arranged at least substantially parallel to the plane of the base part 3.

After the pivoting into the working position, a food item 20 is placed onto a cutting side of the food slicer 5. The cutting part is that side of the actuation part 4 which faces away from the container 18 and on which the vertical blades 13 and the cutting edge 12 are provided.

The food item 20 can be sliced by means of the cutting edge 12 and additionally cut into pieces by means of the vertical blades 13. The food items 20 that have been sliced and/or cut into pieces fall through the through opening 19 into the container 18 and are collected there. After or during the processing of the food items 20, the food slicer 5 can be pivoted away from the base part 3 into the position shown in FIG. 2, in order to access the food items 20 situated in the container 18 or in order, by way of a control element situated on the rear side of the food slicer 5, to adjust the cutting thickness and/or the cutting form.

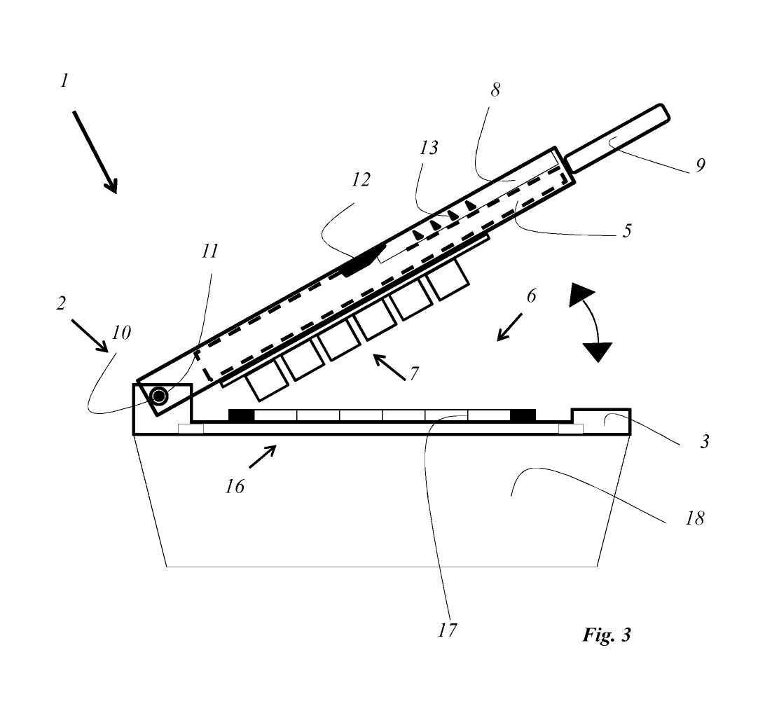

FIG. 3 shows a cross section, from a side elevation, of a further exemplary embodiment of a device 1 according to the invention, wherein the device 1 is constructed in substantially the same way as the device illustrated in FIG. 2. A difference between the two devices consists in the design of the food slicer 5.

Accordingly, in the device 1 illustrated in FIG. 3, the food slicer 5 has a support 8. The support 8 is articulatedly connected at one end to the base part 3 by way of the joint 2. A pressing plunger 7 is attached to that side of the support 8 which points toward the receptacle of the base part 3. A further difference between the two devices 1 described above consists in that, in the device 1 illustrated in FIG. 3, a cutting part 6 is arranged in the receptacle 16.

The pressing plunger 7 has a multiplicity of depressions which divide the pressing plunger 7 into a multiplicity of individual plungers. When the food slicer 5 is pivoted in the direction of the base part 3, the cutting part blades 17 of the cutting part 6 protrude, with corresponding form, into the depressions of the pressing plunger 7. In this case, the spatial extent of said individual plungers, which defines the depth of protrusion thereof into the cutting part 6 between the individual cutting part blades 17, is selected to be of such a size that said individual plungers can protrude completely between the cutting part blades 17.

During a pivoting movement of the food slicer 5, the pressing plunger 7 pushes against a food item 20 situated on the cutting part 6, in such a way that said food item is pushed through the cutting part 6. By being pushed through, the food item 20 is cut into pieces by the cutting part blades 17. It then falls into the container 18 and is collected there.

For example after the food item 20 has been cut into pieces, the user can detach the pressing plunger 7 from the support 8 and remove the cutting part 6 from the receptacle 16. The construction of the device 1 thus substantially corresponds to the device illustrated in FIG. 2, which is provided for slicing.

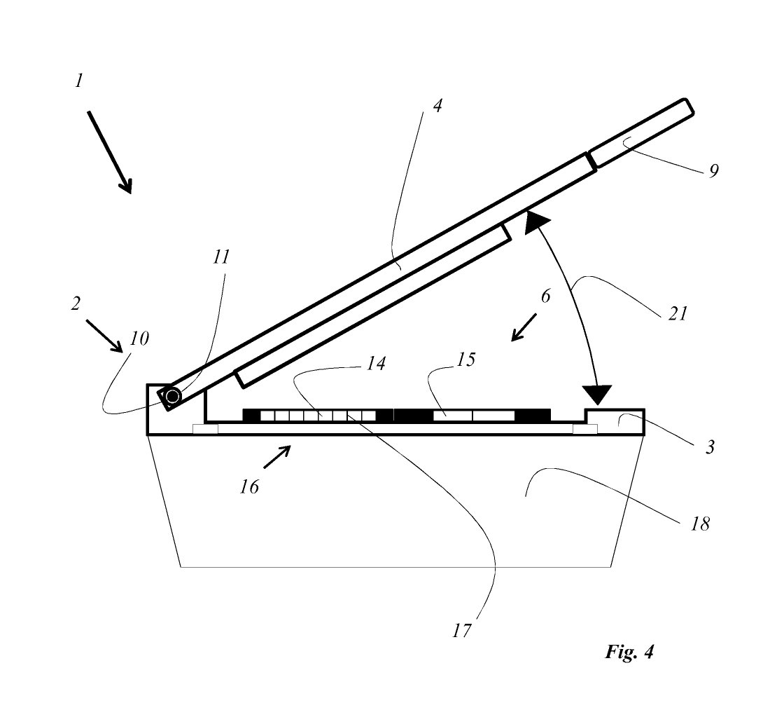

FIG. 4 shows a cross section, from a side elevation, of a further exemplary embodiment of a device 1 according to the invention. The device 1 illustrated in FIG. 4 is similar to the device 1 illustrated in FIG. 1. A difference between the two devices consists in the differently designed base part 3.

The base part 3 has a receptacle 16 in which two cutting parts 14, 15 are arranged, said cutting parts in particular being designed differently than one another. The two cutting parts 14, 15 may differ from one another in terms of the arrangement and/or design of the cutting part blades 17. Furthermore, the two cutting parts 14, 15 are arranged in the receptacle 16 at the same time, and lie in a common plane. Analogously to the devices illustrated in the other figures, the actuation part 4 is articulatedly connected to the base part 3. An internal angle formed between the base part 3 and the actuation part 4 is indicated by a double arrow 21. It is clear that, during a pivoting movement of the actuation part 4, the internal angle 21 correspondingly changes.

A user has the possibility of using two different cutting parts 14, 15 simultaneously for cutting food items 20 into pieces. For this purpose, the user pivots the actuation part 4 toward the two cutting parts 14, 15. In this way, the food items 20 situated on the cutting parts 14, 15 are pushed through said cutting parts and are cut into pieces by the cutting part blades 17. The food items 20 then fall directly into the container 18. For alternative use, the user may exchange the illustrated cutting parts 14, 15 for other cutting parts (not illustrated), for example cutting parts with different blade arrangements.

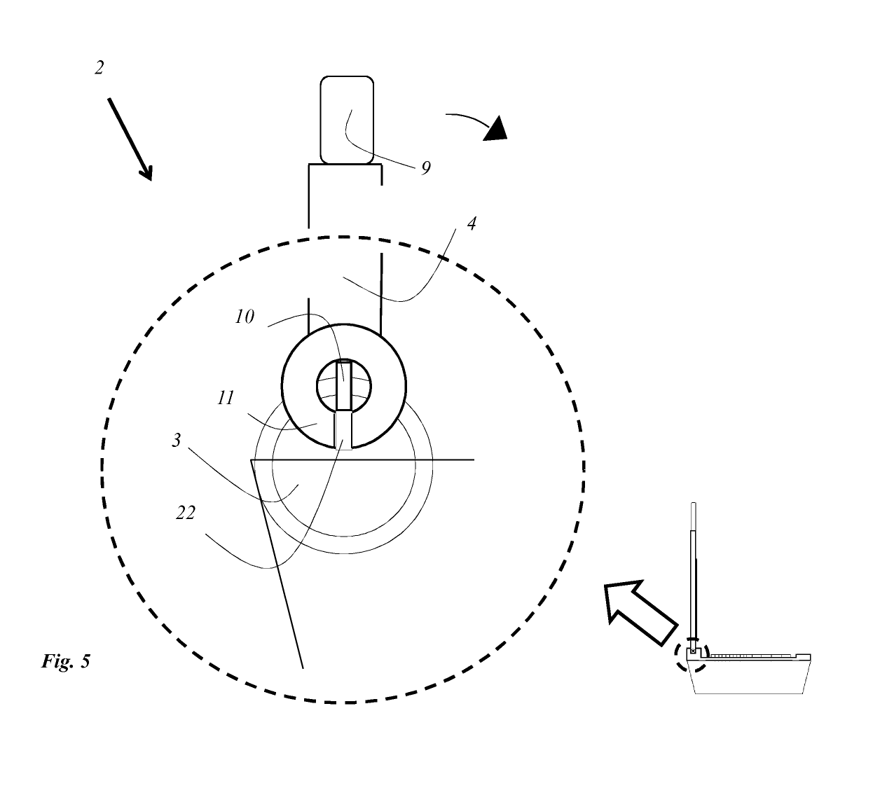

FIG. 5 shows, in a side view, an enlarged illustration of the joint 2, in a position of the actuation part 4 in which the latter encloses an internal angle of 90° with the base part 3. Such a design of the device 1 is shown in FIG. 5 alongside the enlarged illustration of the joint 2, wherein the joint 2 may be a hinged joint.

The actuation part 4 has the joint receptacle 11 which is of annular form in cross section and which has a passage 22. The base part 4 has the joint head 10. The passage 22 is dimensioned and designed such that the cuboidal joint head 10 can be detached from the joint receptacle 11 via said passage. The illustrated positions of the joint head 10 and of the joint receptacle 11 are oriented relative to one another such that, when a user pulls on the actuation part 4 perpendicularly to the base part 3, the joint receptacle 11 is detached from the joint head 10. This means that, in the illustrated position, a longitudinal axis of the joint ahead 10 is oriented coaxially with respect to a longitudinal axis of the passage 22.

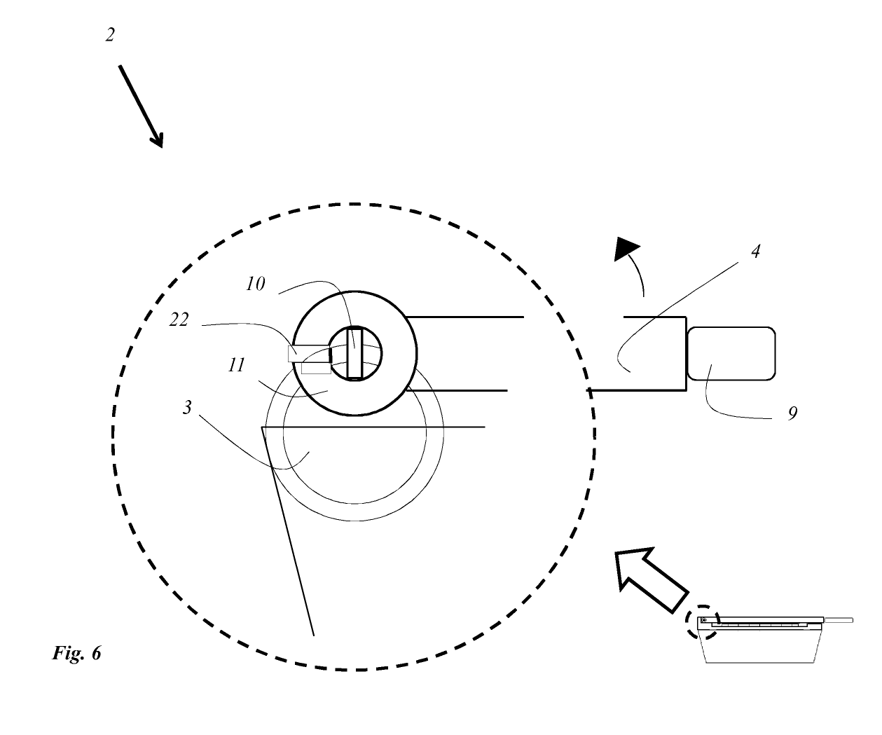

FIG. 6 shows, in a side view, an enlarged illustration of the joint 2, in a position of the actuation part 4 in which the latter encloses an internal angle of 0° with the base part 3. In this position, the actuation part 4 has been pivoted toward the base part 3 to the furthest possible extent. The different internal angle between the actuation part 4 and the base part 3 also gives rise to a changed position of the joint receptacle 11 relative to the cuboidal joint head 10. In the position illustrated in FIG. 6, radial separation of joint head 10 and joint receptacle 11 is not possible. Furthermore, it can be seen that the longitudinal axis of the joint head 10 is situated transversely, in particular perpendicularly, with respect to the longitudinal axis of the passage 22. Owing to this, the joint head 10 cannot be guided through the passage 22, and thus no decoupling of the joint head 10 from the joint receptacle 11 is possible.

### LIST OF REFERENCE NUMERALS:

1 Device

2 Joint

3 Base part

4 Actuation part

5 Food slicer

6 Cutting part

7 Pressing plunger

8 Support

9 Handle

10 Joint head

11 Joint receptacle

12 Cutting edge of the food slicer

13 Vertical blade of the food slicer

14 Cutting part with first blade arrangement

15 Cutting part with second blade arrangement

16 Receptacle

17 Cutting part blades

18 Vessel Container

19 Through opening

20 Food items

21 Internal angle

22 Passage

1. Device (1) for the comminution of foodstuffs, having a base part (3) which has a receptacle for a cutting part (6) and to which an actuation part (4) can be articulatedly fixed such that, for pushing through food items (20) to be comminuted, the actuation part (4) can be pivoted toward the cutting part (6), characterized in that
a. a food slicer (5) is provided which, as a replacement for the actuation part (4) or in addition to the actuation part (4), is articulatedly fixable or fixed to the base part (3).

2. Device (1) according to claim 1, characterized in that
a. the base part (3), on the one hand, has at least one joint head (10) and the actuation part (4) and/or or the food slicer (5), on the other hand, has a corresponding joint receptacle (11) for forming the articulated connection, or in that
b. the actuation part (4) and/or or the food slicer (5), on the one hand, has at least one joint head (11) and the base part (3), on the other hand, has a corresponding joint receptacle (11) for forming the articulated connection.

3. Device (1) according to claim 1, characterized in that
a. the articulated connection is designed such that the actuation part (4) or the food slicer (5), at least in a predefined pivoting position, is detachable from the base part (3), in particular without tools and/or exclusively by virtue of the actuation part (4) and base part (3) being pulled apart, and/or in that
b. the articulated connection is designed such that the actuation part (4) or the food slicer (5), exclusively in a predefined pivoting position or in a predefined pivoting position range, is detachable from the base part (3), in particular without tools and/or exclusively by virtue of the actuation part (4) and base part (3) being pulled apart.

4. Device (1) according to claim 3, characterized in that
a. the predefined pivoting position lies at an angle in the range from 80° to 100°, in particular at an angle of 90°, between the plane of the base part (3) and the plane of the actuation part (4), and/or in that
b. the predefined pivoting position range has an angle range of 70° to 110°, in particular of 80° to 100°, in particular of 85° to 95°, between the plane of the base part (3) and the plane of the actuation part (4).

5. Device (1) according to claim 2, characterized in that
a. the joint receptacle (11) has a radial opening through which the joint head (10) can be removed from or inserted into the joint receptacle (11) in a radial direction, and/or in that
b. the joint receptacle (11) has an opening through which the joint head (10) can be removed from or inserted into the joint receptacle (11) along a direction that differs from the direction of the pivot axis of the articulated connection.

6. Device (1) according to claim 2, characterized in that the joint head (10) is of non-circular, in particular rectangular, form in cross section, and/or in that the articulated connection is in the form of a hinged joint.

7. Device (1) according to claim 1, characterized in that the device (1) has at least one drive device, in particular a spring drive, for assisting or effecting the pivoting movement of the actuation part (4) and/or of the food slicer (5) from a closed position into a loading position and/or from a loading position into a closed position.

8. Device (1) according to claim 7, characterized in that the drive device is selectively activatable or deactivatable and/or in that the assistance force of the drive device is adjustable.

9. Device (1) according to claim 1, characterized in that the base part (3) has a through opening (19) for the comminuted food items (20) and/or in that the receptacle (16) for the cutting part (6) provides, when no cutting part (6) is inserted into the receptacle (16), a through opening (19) for the food items (20) that have been comminuted by means of the food slicer (5).

10. Device (1) according to claim 1, characterized in that multiple cutting parts (14, 15) can be inserted simultaneously into the receptacle (16) and/or in that cutting parts (14, 15) of different size can be inserted into the receptacle (16).

11. Device (1) according to claim 1, characterized in that the food slicer (5) has at least one control element by means of which a cutting thickness and/or a cutting pattern can be adjusted.

12. Device (1) according to claim 11, characterized in that the at least one control element is arranged on that side of the food slicer (5) which faces away from the cutting side of the food slicer (5).

13. Device (1) according claim 1, characterized in that the device (1) is designed to be placed on a worktop for a comminution process, and/or in that the device (1) has a stand for placing on a worktop.

14. Device (1) according to claim 1, characterized in that the device (1) is in the form of a cover which can be mounted onto a container (18)—preferably so as to completely cover the container opening—and/or can be fixed to a container (18).

15. Device (1) according to claim 1, characterized in that
a. the base part (3) is in the form of a container (18) for the comminuted food items (20), and/or in that
b. the base part (3) is in the form of a stand for enabling the device (1) to be placed on a worktop or has a stand for enabling the device (1) to be placed on a worktop.

16. Kitchen appliance having a device (1) according to claim 1, said device being in the form of a cover, and having a container (18) onto which the device (1) is mounted—preferably so as to completely cover the container opening—and/or to which the device (1) is fixed, preferably so as to be detachable again without tools.

17. Kitchen appliance according to claim 16, characterized in that
a. the container (18) is in the form of a stand for enabling the device (1) to be placed on a worktop, and/or in that
b. the kitchen appliance is designed to be placed on a worktop for a comminution process.

18. Device (1) according to claim 1, characterized in that, instead of a food slicer (5) which, as a replacement for the actuation part (4) or in addition to the actuation part (4) is articulatedly fixable or fixed to the base part (3), the actuation part (4) has a support (8) to which at least one pressing plunger (7) is fixable or fixed, preferably in detachable fashion, wherein a food slicer (5) forms the support (8) or has the support (8), and wherein the device (1) has at least one drive device, in particular a spring drive, for assisting or effecting the pivoting movement of the actuation part (4) and/or of the food slicer (5) from a closed position into a loading position and/or from a loading position into a closed position
